(19) United States
(12) Patent Application Publication
(10) Pub. No.: US 2022/0131349 A1
(43) Pub. Date: Apr. 28, 2022

(54) Telescoping Cable Pulling Device

(71) Applicant: James Harrell, Rocky Mount, NC (US)

(72) Inventor: James Harrell, Rocky Mount, NC (US)

(21) Appl. No.: 17/501,363

(22) Filed: Oct. 14, 2021

Related U.S. Application Data
(60) Provisional application No. 63/106,570, filed on Oct. 28, 2020.

(51) Int. Cl. H02G 1/08

(52) U.S. Cl. CPC H02G 1/081

(57) ABSTRACT

The present invention relates to a telescopic cable and wire-pulling device. The device allows an user to easily pull and install cables in high places, such as a ceiling, without risk of injuries. The cable-pulling device comprises an elongated telescopic pole having a plurality of telescoping segments for adjusting the length of the pole. Each telescoping segment is six feet in length, and can be extended or retracted using slip locks or any other similar telescoping locking mechanism. The device further has a hook on the distal end and a mechanical trigger on the proximal end. The mechanical trigger is depressed to actuate and control the hook for gripping a wire or a cable for pulling down and/or installing the wire or cable at a desired place.

### CROSS-REFERENCE TO RELATED APPLICATION

The present application claims priority to, and the benefit of, U.S. Provisional Application No. 63/106,570, which was filed on Oct. 28, 2020 and is incorporated herein by reference in its entirety.

### FIELD OF THE INVENTION

The present invention relates generally to the field of cable installation tools. More specifically, the present invention relates to a telescopic cable-pulling pole with a trigger that allows a cable installer to easily install a cable in a high place, such as a ceiling, without risk of injury. The cable-pulling pole device comprises an elongated telescopic pole having a plurality of telescoping segments for adjusting the length of the pole. The device further comprises a clamping hook on a first end, and a mechanical trigger button on a second end. The second end of the pole device generally comprises a gripping handle that allows the user to properly hold the device while installing a cable. Accordingly, the present disclosure makes specific reference thereto. Nonetheless, it is to be appreciated that aspects of the present invention are also equally applicable to other like applications, devices and methods of manufacture.

### BACKGROUND

By way of background, cables are required to be installed in many different places including, without limitation, houses, offices, schools, hospitals, hotels, etc. Cable installation is generally required to facilitate electrical connectivity, wireless communication and other similar services at a desired location. To install a cable across an attic, drop ceiling or other area, various kinds of tools are oftentimes required to hold or grab the cable, launch the cable, etc.

Generally, cable installers may use ladders to install cables in high places. When installing cable in high places, it is necessary for the cable installer to have the correct ladder on site that meets OSHA guidelines to ensure workplace safety. If the ladder does not meet the required guidelines, the workers' safety is at risk while installing cables using the ladder. Further, even if the ladder meets safety guidelines, there is always a risk of injury whenever any ladder is involved in a job. For example, a worker can become imbalanced while climbing a ladder and may accidently fall from the ladder. This may cause serious injuries to the worker.

Apart from this, ladder installation generally requires the ladder to be placed in a slanting manner across a wall or an attic, thereby requiring an adequate space in the area. Accordingly, when sharing a workspace with others, issues of needing adequate space for a ladder may arise. Additionally, users may have difficulties with ladder placement in areas that are extremely small and already full of furniture.

Further, use of ladders for cable installation is a time-consuming process, as it requires set up and take down of the ladder which adds additional time to the task. Due to this, users may find cable installation a time-consuming and tiresome task.

Therefore, there exists a long felt need in the art for a device that makes it easy to install cables over drop ceilings, attics, etc. There is also a long felt need in the art for a device that ensures that cables are easily installed without using multiple tools to access the cables over ceilings, attics, etc. Additionally, there is a long felt need in the art for a cable-pulling device that eliminates the need to use ladders for cable installation. Moreover, there is a long felt need in the art for a cable accessing device that prevents the use of ladders, and therefore prevents users from injuries due to accidental falls from the ladder. Further, there is a long felt need in the art for a device that allows cable installation in small areas. Furthermore, there is a long felt need in the art for a cable-pulling device that is portable and can be easily carried to desired locations, and eliminates the need to set up and take down ladders for cable installation. Finally, there is a long felt need in the art for a cable installation tool that helps in pulling cable in a quick, convenient and easy manner.

The subject matter disclosed and claimed herein, in one embodiment thereof, comprises a cable pull and maneuvering device that is designed to allow for the easy maneuvering of cables and wires in high and hard to reach spaces, such as a ceiling and in the space between walls. The device comprises a telescoping pole having a plurality of telescoping segments, that enables a user to adjust the device length as per the height requirements of the ceiling or any other area where the cable is located. The device further includes an ergonomic grip having a mechanical trigger to control a hook or a pull arm for grabbing and pulling cables. Additionally, the device includes a lock for locking the pole length per the user's needs and/or desires.

In this manner, the novel telescopic cable pulling device of the present invention accomplishes all of the forgoing objectives, and provides a relatively safe, easy and convenient solution to pulling cables from ceilings, drop ceilings, attics, etc. The cable pulling device of the present invention is also user friendly, as it eliminates the use of ladders for cable installation, and ensures that users are safe from injuries while installing cables. With this, the cable pulling device saves users time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable pull and maneuvering device. The device is configured to allow for the easy maneuvering of cables and wires in high and hard to reach spaces, such as a ceiling and the space between walls. The device further comprises a telescoping pole having a plurality of telescoping segments, an ergonomic grip, a mechanical trigger disposed on said grip, a hook disposed on the top end of the pole. The mechanical trigger is configured to control the hook, wherein the hook securely grabs a wire or cable when the mechanical trigger is depressed by a user of the device. The mechanical trigger is coupled to the hook through a coupling wire, thereby allowing the trigger to actuate the hook when the trigger is depressed.

In a further embodiment of the present invention, a telescoping device for pulling cables and wires from hard-to-reach areas is disclosed. The device includes a telescoping pole having three telescoping segments that can be extended or retracted to adjust the length of the telescoping pole. The pole further comprises an ergonomic grip at one end and a hook at the opposite end, wherein the hook grabs the wire or cable and enables an operator to pull the wire or cable down and maneuver it to a different place. The hook can be operated using a mechanical trigger disposed on the ergonomic grip for grabbing the wire or the cable.

In a further embodiment of the present invention, the hook is connected to a torsional spring disposed within the telescoping pole, allowing the mechanical trigger to release the hook when the trigger is depressed by an operator.

In yet another embodiment of the present invention, the device can be used for speaker wires, Ethernet cables, phone wires, cable wires and other types of cables and wires.

In yet another embodiment of the present invention, the telescoping pole has a bottom telescoping segment, a middle telescoping segment and a top telescoping segment. Each telescoping segment may have a locking mechanism to lock the length of the telescoping segments to a desired length, wherein the locking mechanism can include one or more of a slip lock, clutch lock, cam lock, spring button, snap lock, set knob or any other suitable lock as is known in the art.

In yet another embodiment of the present invention, a method for safely pulling cables and wires from a ceiling is described. The method includes the steps of adjusting the length of the telescoping pole of the cable pull device by locking a plurality of the telescoping segments. Then, placing the hook on a wire that is to be pulled by an user and depressing a mechanical trigger disposed on the grip of the device, for actuating the hook to grab the wire. The mechanical trigger allows the hook to grip the wire, enabling the user to pull the wire down and maneuver it to a different place.

The advantage of the cable and wire pull device of the present invention is that it eliminates the need to use a ladder to access cables in the ceiling, and offers an easy and convenient solution to needing to install cable in high, hard to access areas of a home or building. The device can range up to eighteen feet in length and has telescoping capabilities for adjusting the length.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the cable pull pole device of the present invention in accordance with the disclosed architecture;

FIG. 2 illustrates a perspective view of one potential embodiment of the coupling of the mechanical trigger and the hook using a wire passing through the telescoping segments of the cable pull device of the present invention in accordance with the disclosed architecture;

FIG. 3 illustrates a perspective view showing the telescoping nature of one potential embodiment of the pole of the cable pull device of the present invention in accordance with the disclosed architecture;

FIG. 4A illustrates a perspective view of one potential embodiment of the ergonomic grip of the cable pull device of the present invention in accordance with the disclosed architecture;

FIG. 4B illustrates a perspective view of one alternative embodiment of the ergonomic grip of the cable pull device of the present invention in accordance with the disclosed architecture;

FIG. 5 illustrates a perspective view showing use of one potential embodiment of the pull cable device of the present invention for pulling a cable or wire from a ceiling in accordance with the disclosed architecture; and

FIG. 6 illustrates a flow chart showing the exemplary steps for one potential use of the cable pull device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that makes it easy to install cables over drop ceilings, attics, etc. There is also a long felt need in the art for a device that ensures the cables are easily installed without using multiple tools to access the cables. Additionally, there is a long felt need in the art for a cable-pulling device that eliminates the need to use ladders for cable installation. Moreover, there is a long felt need in the art for a cable-accessing device that prevents the use of ladders and therefore prevents users from injuries due to accidental falls from the ladder. Further, there is a long felt need in the art for a device that allows cable installation in small areas. Furthermore, there is a long felt need in the art for a cable-pulling device that is portable and can be easily carried to desired locations, and eliminates the need to set up and take down ladders for cable installation. Finally, there is a long felt need in the art for a cable installation tool that helps in pulling cable in a quick, convenient and easy manner.

The present invention, in one exemplary embodiment, is a novel cable-pulling device. The cable-pulling device is designed to pull cables and wires from hard-to-reach areas while installing cables. The device includes a telescoping pole having three telescoping segments that can be extended or retracted to adjust the length of the telescoping pole. The pole comprises an ergonomic grip at one end and a hook at the opposite end, wherein the hook grabs the wire or cable and enables an user to pull the wire or cable down and maneuver it to a different place. The hook can be operated using a mechanical trigger disposed on the ergonomic grip, for grabbing the wire or the cable.

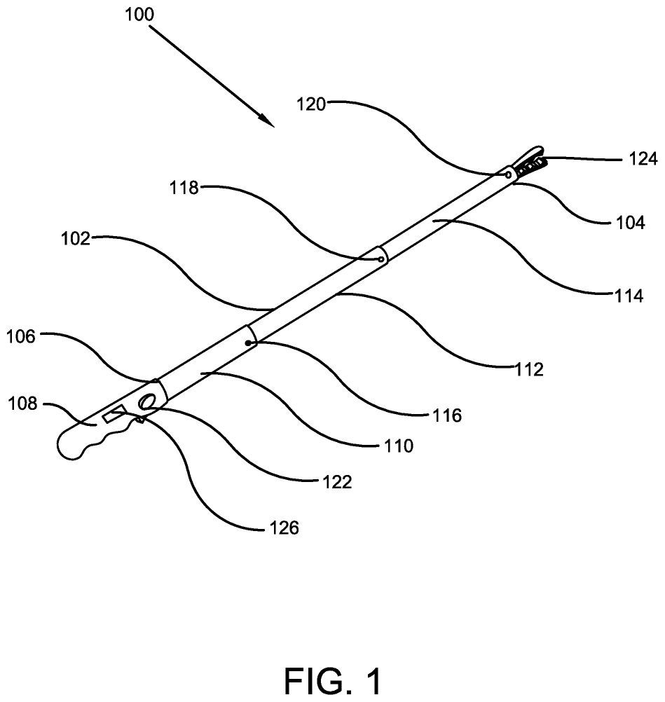

Referring initially to the drawings, FIG. 1 illustrates a perspective view of one embodiment of the cable pull pole device of the present invention. The cable pull pole device 100 of the present invention is a device configured to allow for easy maneuvering of cables, such as Ethernet, speaker cables, etc., and any other suitable type of cable as is known in the art, in high or hard to reach spaces, such as ceilings, attics, etc., or any other suitable place as is known in the art. The device 100 can be constructed of a non-conductive or conductive material as per a user's needs and/or requirements, or any other suitable material as is known in the art and can be used by both professional and naïve users. More specifically, the device 100 has a telescoping pole 102 having a distal end 104 and a proximal end 106. The proximal end 106 has an ergonomic grip 108 for holding the device 100 during use. Preferably, the telescoping pole 102 has three telescoping segments, a bottom telescoping segment 110, a middle telescoping segment 112 and a top telescoping segment 114, however the telescoping pole 102 can have any suitable number of telescoping segments known in the art depending on a user's wants and/or needs. Each telescoping segment is approximately six feet in length, but can be any suitable length as is known in the art, and can be locked at a specific length using respective slip locks, or any other suitable locking mechanism as is known in the art. Specifically, the bottom telescoping segment 110 has a first slip lock 116, the middle telescoping segment 112 has a second slip lock 118 and the top telescoping segment 114 has a third slip lock 120.

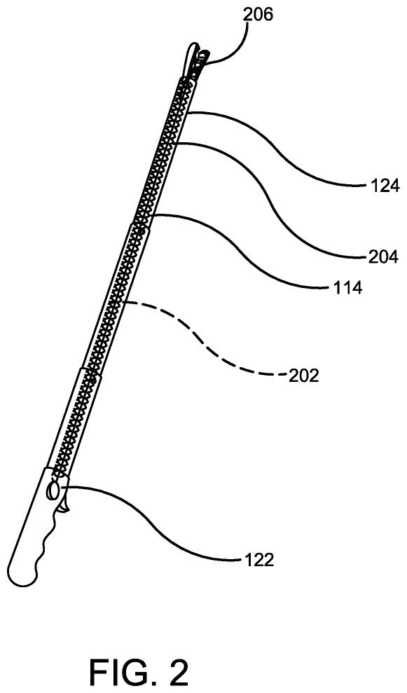

The grip 108 of the device 100 further comprises a mechanical trigger 122 that is coupled to a hook or pull arm 124, wherein the pull arm 124 is positioned at the distal end 104 of the pole 102. Specifically, the hook or pull arm 124 is positioned at the top of the top telescoping segment 114. The mechanical trigger 122 is coupled to the hook 124, using a wire for actuating the hook 124 and operating the trigger 122, as best shown in FIG. 2. The telescoping segments 110, 112, 114 allow a wire puller/installer/operator/user to pull wires from a ceiling, wall, etc., without need for a ladder. Additionally, the telescoping segments 110, 112, 114 provide sufficient reach for the device 100 to reach and engage a conduit in a ceiling, attic, etc. The hook 124 is formed with a slot, such that any point along a wire may be placed into the slot of the hook 124. The user can then use the mechanical trigger 122 to secure the wire in the hook or pull arm 124, which pulls the desired wire. The grip 108 can also comprise an optional central lock 126, that enables the user to activate or deactivate the telescoping functionality of the device 100.

The cable pull device 100 can be used for installing or rewiring different types of wires, including electrical wires, speaker wires, phone, or internet cables, etc. The device 100 can also be used to run new wires through an existing conduit or pipe. When the device 100 is made of fiberglass, the pole 102 can be flexible and enables users to easily route cables, saving time, and allowing for use in hard-to-reach places, (i.e., spaces between walls).

FIG. 2 illustrates a perspective view showing the coupling of the mechanical trigger 122 and the hook 124 using a wire 202 passing through the telescoping segments of the cable pull device of the present invention. The mechanical trigger 122 positioned at the grip 108 is configured to mechanically control and operate the hook 124 for grabbing and maneuvering a wire or cable. Specifically, an elastic wire 202 runs through the length of the pole 102 from the mechanical trigger 122 to a torsional spring 204 positioned at the distal end of the top telescoping segment 114. The torsional spring 204 is attached to the hook 124 and is used for actuating the hook 124, to open the slot 206 to grab a wire or cable, when the mechanical trigger 122 is pressed by a user.

More specifically, when the mechanical trigger 122 is pushed, the elastic wire 202 is stretched, allowing the torsional spring 204 to release the hook 124, which allows the slot 206 to open, and thus enables a user to securely grab a wire or cable. The mechanical trigger 122, when released by the user, allows the torsional spring 204 to latch to the hook 124, thus closing the slot 206, such that the wire or the cable remains securely retained within the slot 206. The slot 206 forms a large swivel angle of the hook 124, making it easy to grab wires and cables without any obstructions and providing optimum accessibility for hard-to-reach areas.

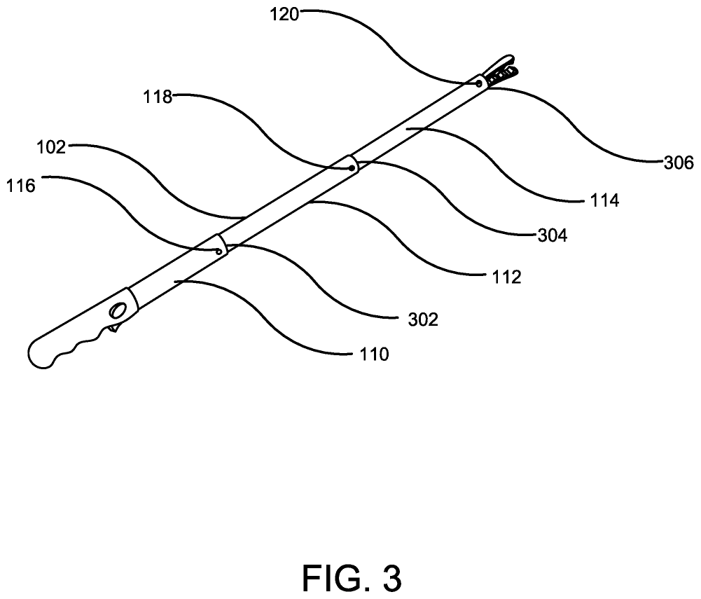

FIG. 3 illustrates a perspective view showing the telescoping nature of the pole 102 of the cable pull device 100 of the present invention. The telescoping pole 102 has at least three telescoping segments 110, 112, 114 that allow the total length of the pole 102 to be extended or retracted. Each telescoping segment 110, 112, 114 is hollow, and has a slip lock for locking the segment at a specific length. The bottom telescoping segment 110 is secured to the grip 108 and the first slip lock 116 is disposed on the distal end 302 of the bottom telescoping segment 110. The first slip lock 116 is used for securing the middle telescoping segment 112 at a specific length extending from the bottom telescoping segment 110. For extending the middle telescoping segment 112, the first slip lock 116 is released by means of pressing or turning the slip lock 116 and when a desired height of the middle telescoping segment 112 is extended or retracted, the first slip lock 116 is locked to lock the middle telescoping segment 112 to a desired length.

Similarly, the middle telescoping segment 112 has a second slip lock 118 disposed at the distal end 304 of the middle telescoping segment 112, for securing the top telescoping segment 114 at a specific extended length from the middle telescoping segment 112. For extending the top telescoping segment 114, the second slip lock 118 is released by means of pressing or turning the second slip lock 118, and when a desired height of the top telescoping segment 114 is extended or retracted, the second slip lock 118 is locked to lock the top telescoping segment 114 to a desired length. The top telescoping segment 114 can also have an optional third slip lock 120 disposed at the distal end 306 of the top telescoping segment 114.

The three segments 110, 112, 114 allow the device 100 to have a length from approximately seven feet to eighteen feet fully extended, allowing a user to easily maneuver cables and wires in high areas without requiring a ladder. Any type of telescoping locks, such as a clutch lock, cam lock, spring button, snap lock, set knob or any other suitable lock as is known in the art, can be used for securing a desired length of the telescoping segments and for securing the telescoping segments to each other, during extension and retraction of the telescoping segments.

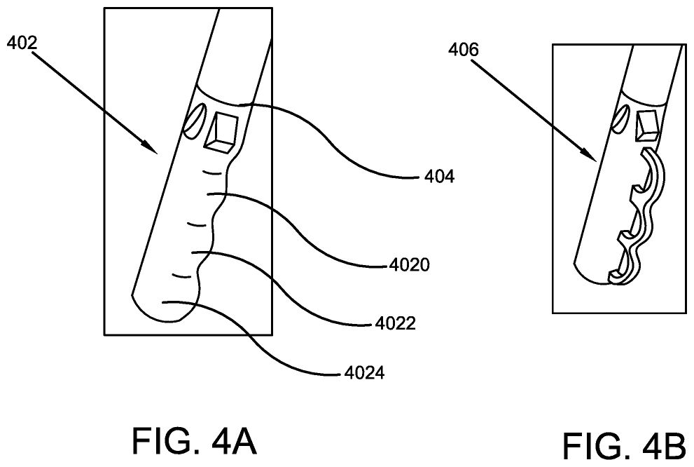

FIGS. 4A and 4B illustrate different embodiments of the ergonomic grip of the device 100 of the present invention. As shown in FIG. 4A, the ergonomic grip can be in the form of a finger grip 402. The finger grip 402 has a plurality of gripping segments 4020, 4022, 4024 for secure and comfortable placement of a user's fingers while operating the device 100. The mechanical trigger 122 is positioned at the top end 404 of the finger grip 402, with the bottom telescoping segment 110 detachably attached to the finger grip 402.

FIG. 4B shows a finger knuckle grip 406 used in the device 100 of the present invention. The finger knuckle grip 406 provides more support to a user's fingers and is useful in cases where a heavy cable needs to be supported by the pull cable device.

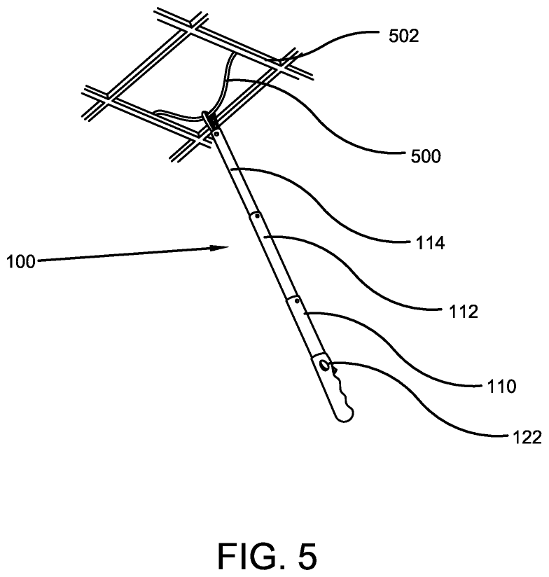

FIG. 5 illustrates a perspective view showing the pull cable device 100 of the present invention in use for pulling a cable or wire from a ceiling. As shown, a wire or cable 500 installed in a ceiling 502 is secured in the hook 124 (shown in FIG. 1) of the device 100. Once secured, the device 100 allows the cable 500 to be pulled and maneuvered from the ceiling 502 to another position, such as another ceiling or a conduit, by depressing the mechanical trigger 122 disposed on the grip 108. Further, the length of the pole 102 can be adjusted using the telescoping segments 110, 112, 114 as per the height of the ceiling 502, prior to use of the device 100.

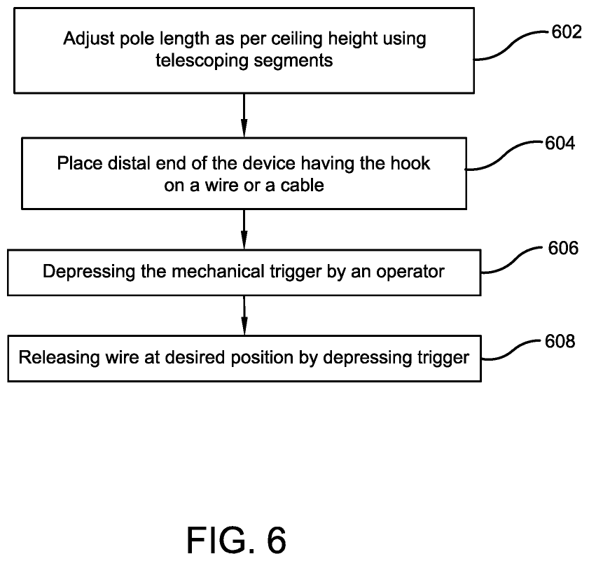

FIG. 6 illustrates a flow chart showing the exemplary steps for use of the cable pull device 100 of the present invention for pulling a wire or cable. Initially, at step 602, the pole length is adjusted as per the height of the ceiling, wall, etc., or any other suitable area from where the cable or wire has to be pulled. Typically, the pole length is adjusted using slip locks. At step 604, the distal end of the device which has the hook, is placed on the wire or the cable which is to be pulled, and wherein the device 100 is held by a user using the ergonomic grip. At step 606, the mechanical trigger is depressed by the user for actuating the hook and gripping the wire, and then the user releases the trigger to secure the wire within the hook. Finally, at step 608, the wire is released at a desired position by again depressing the trigger, which opens the slot of the hook and which releases the secured and gripped wire or cable. When the mechanical trigger is released, the hook can adhere to the pole and when the mechanical trigger is depressed, the hook can extend from the pole of the device.

Certain terms are used throughout the following description and claim to refer to particular features or components. As one skilled in the art will appreciate, different persons may refer to the same feature or component by different names. This document does not intend to distinguish between components or features that differ in name but not structure or function. As used herein “cable pull device”, “telescoping cable pull device”, “wire pull device”, “cable installer device”, “device” and “installer device”, are interchangeable and refer to the telescoping cable pull device 100 of the present invention.

Notwithstanding the foregoing, the telescoping cable pull device 100 of the present invention can be of any suitable size and configuration as is known in the art without affecting the overall concept of the invention, provided that it accomplishes the above-stated objectives. One of ordinary skill in the art will appreciate that the size, configuration and material of the telescoping cable pull device 100 as shown in FIGS. 1-6 is for illustrative purposes only, and that many other sizes and shapes of the telescoping cable pull device 100 are well within the scope of the present disclosure. Although the dimensions of the telescoping cable pull device 100 are important design parameters for user convenience, the telescoping cable pull device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable pull pole device configured to allow for ease in maneuvering a cable in high and hard-to-reach spaces, the cable pull pole device comprising:
a pole comprising a distal end and a proximal end;
a hook positioned on the distal end; and
a grip positioned on the proximal end of the pole, wherein the grip comprises a mechanical trigger that is coupled to the hook, such that once depressed, the mechanical trigger actuates the hook to grasp and retain a cable, and further wherein the retained cable can be maneuvered to a desired position and then released by depressing the mechanical trigger again.

2. The cable pull pole device of claim 1, wherein the pole is telescoping.

3. The cable pull pole device of claim 2, wherein the pole comprises three telescoping segments.

4. The cable pull pole device of claim 3, wherein the three telescoping segments comprise a bottom telescoping segment, a middle telescoping segment, and a top telescoping segment.

5. The cable pull pole device of claim 4, wherein each of the three telescoping segments is approximately six feet in length.

6. The cable pull pole device of claim 5, wherein each of the three telescoping segments comprises a slip lock which allows each of the three telescoping segments to be locked at a specific length.

7. The cable pull pole device of claim 6, wherein the grip comprises a central lock that enables a user to activate or deactivate telescoping functionality of the cable pull pole device.

8. The cable pull pole device of claim 7, wherein the mechanical trigger is coupled to the hook via an elastic wire which passes through each of the three telescoping segments for actuating the hook.

9. The cable pull pole device of claim 8, wherein the elastic wire engages a torsional spring positioned at a distal end of the top telescoping segment.

10. The cable pull pole device of claim 9, wherein the torsional spring is attached to the hook and is used for actuating the hook.

11. The cable pull pole device of claim 10, wherein the hook comprises a slot for retaining and securing the cable in the hook.

12. The cable pull pole device of claim 1, wherein the grip is an ergonomic finger grip.

13. The cable pull pole device of claim 1, wherein the grip is an ergonomic finger knuckle grip.

14. A cable pull pole device configured to allow for ease in maneuvering a cable in high and hard-to-reach spaces, the cable pull pole device comprising:
a telescoping pole comprising a distal end and a proximal end, wherein the telescoping pole comprises a bottom telescoping segment, a middle telescoping segment, and a top telescoping segment, and further wherein the bottom, the middle, and the top telescoping segments comprise a slip lock which allows each of the bottom, the middle, and the top telescoping segments to be locked at a specific length;
a hook positioned on the distal end, wherein the hook comprises a slot for retaining a cable; and
a grip positioned on the proximal end of the pole;
wherein the grip comprises a mechanical trigger that is coupled to the hook via an elastic wire and a torsional spring; and
wherein the elastic wire passes through the bottom, the middle, and the top telescoping segments to the torsional spring;
wherein the torsional spring is attached to the hook and is used for actuating the hook to open the slot to grasp and retain the cable, when the mechanical trigger is depressed by a user; and
further wherein the retained cable can be maneuvered to a desired position and then released by depressing the mechanical trigger again.

15. The cable pull pole device of claim 14, wherein the bottom telescoping segment is secured to the grip and a first slip lock is disposed on a distal end of the bottom telescoping segment.

16. The cable pull pole device of claim 15, wherein the first slip lock secures the middle telescoping segment at a specific length extending from the bottom telescoping segment.

17. The cable pull pole device of claim 16, wherein the middle telescoping segment comprises a second slip lock disposed at a distal end of the middle telescoping segment.

18. The cable pull pole device of claim 17, wherein the second slip lock secures the top telescoping segment at a specific extended length from the middle telescoping segment.

19. The cable pull pole device of claim 18, wherein the top telescoping segment comprises a third slip lock disposed at a distal end of the top telescoping segment.

20. A method of grasping and maneuvering a cable using a cable pull pole device comprising the steps of:
adjusting pole length of the telescoping pole per height of area from where a cable is being adjusted or pulled;
utilizing slip locks to adjust the telescoping segments of the telescoping pole;
utilizing a hook on a distal end of the cable pull pole device to grasp and retain the cable;
depressing a mechanical trigger to actuate the hook to grasp and retain the cable;
releasing the mechanical trigger to secure the cable within the hook; and
depressing the mechanical trigger which opens the slot of the hook to release the cable at a desired position.
